(19) United States
(12) Patent Application Publication
(10) Pub. No.: US 2018/0182160 A1
(43) Pub. Date: Jun. 28, 2018

(54) VIRTUAL OBJECT LIGHTING

(71) Applicants: Michael G. Boulton, Seattle, WA (US); Yang You, Redmond, WA (US)

(72) Inventors: Michael G. Boulton, Seattle, WA (US); Yang You, Redmond, WA (US)

(21) Appl. No.: 15/390,387

(22) Filed: Dec. 23, 2016

(51) Int. Cl. G06T 15/50; G06T 19/00

(52) U.S. Cl. CPC G06T 15/506; G06T 2215/16; G06T 2215/12; G06T 19/006

(57) ABSTRACT

A method for lighting virtual objects includes recognizing a three-dimensional representation of a physical environment, and recognizing a three-dimensional world-space position for a virtual object in the physical environment. Based on the three-dimensional representation, a cube map is generated that defines lighting conditions of the physical environment at the three-dimensional world-space position. From the cube map, a spherical harmonic lighting model having a predetermined order is derived. The virtual object is presented at the three-dimensional world-space position with environmental lighting effects based on the spherical harmonic lighting model.

### BACKGROUND

Head mounted display devices (HMDs) can be used to provide augmented reality (AR) experiences and/or virtual reality (VR) experiences by presenting virtual imagery to a user. Virtual imagery can take the form of one or more virtual objects that are presented such that they appear as though they are physical objects in the real world.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for lighting virtual objects includes recognizing a three-dimensional representation of a physical environment, and recognizing a three-dimensional world-space position for a virtual object in the physical environment. Based on the three-dimensional representation, a cube map is generated that defines lighting conditions of the physical environment at the three-dimensional world-space position. From the cube map, a spherical harmonic lighting model having a predetermined order is derived. The virtual object is presented at the three-dimensional world-space position with environmental lighting effects based on the spherical harmonic lighting model.

### BRIEF DESCRIPTION OF THE DRAWINGS

FIG. 1 schematically shows an example physical environment including a virtual object visible to a wearer of an augmented reality computing device.

FIG. 2 illustrates an example method for lighting virtual objects.

FIG. 3 schematically shows an example three-dimensional representation of a physical environment.

FIG. 4 schematically shows a cube map defining lighting conditions of a physical environment.

FIG. 5 schematically illustrates derivation of a spherical harmonic lighting model from a cube map.

FIG. 6 schematically shows an example physical environment including a virtual object presented with environmental lighting effects.

FIG. 7 schematically illustrates lighting of a virtual object with environmental lighting effects during multiple time frames.

FIGS. 8A and 8B schematically illustrate presentation of a virtual object to a wearer of an augmented reality computing device.

FIG. 9 schematically shows an example augmented reality computing device.

FIG. 10 schematically shows an example computing system.

### DETAILED DESCRIPTION

Augmented reality computing devices may be used to present virtual objects that appear to occupy three-dimensional positions in a surrounding environment. Such virtual objects can look more tangible and realistic when they are presented with lighting effects consistent with lighting conditions in the real world environment. Therefore, it is desirable for augmented reality computing devices to be configured to evaluate environmental lighting conditions, and take such conditions into account when presenting virtual objects. For example, if a virtual object occupies a position that falls within a shadow cast by another object, then a brightness of the virtual object may be reduced in order to mimic how a physical object would appear if it occupied the same position. Similarly, if the virtual object is brought into close proximity with a light source producing red light, then a red tint of a portion of the virtual object facing the light source can be increased, again mimicking how a physical object would be affected by the red light.

Accordingly, the present disclosure is directed to a technique for lighting virtual objects based on environmental lighting conditions of a physical environment. In particular, a three-dimensional representation of the physical environment can be used to generate a cube map, which can then be projected into a spherical harmonic lighting model. A virtual object is then presented at a particular three-dimensional world-space position with lighting effects based on the spherical harmonic lighting model and consistent with lighting conditions in the physical environment. As compared to other virtual object lighting techniques, lighting virtual objects in this manner can provide for a more immersive virtual reality experience, while requiring less computer memory and processing power.

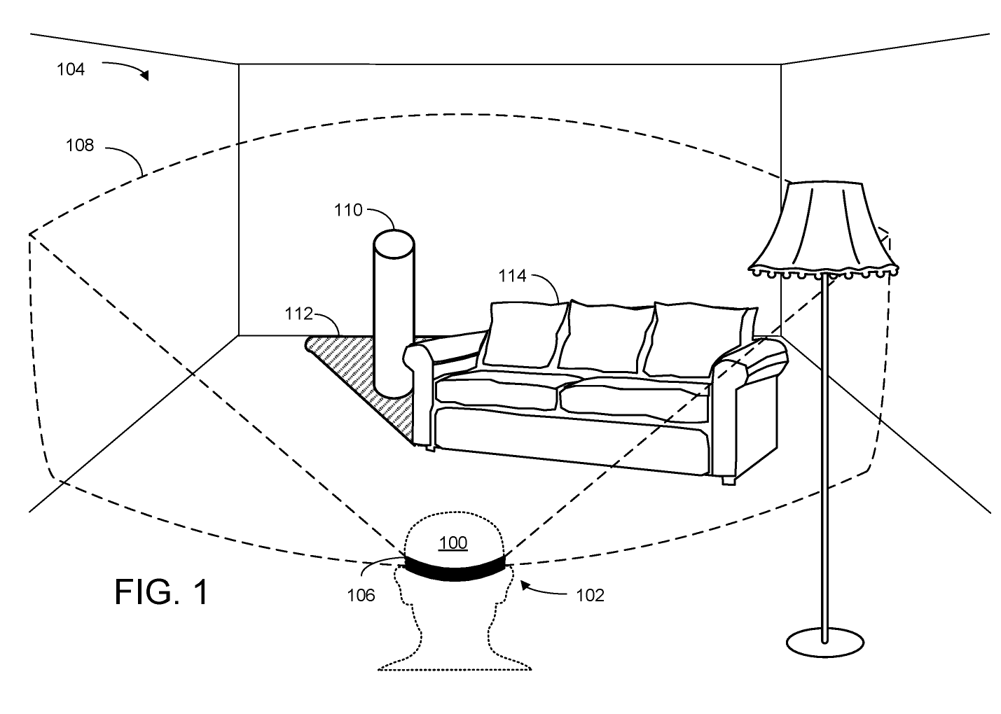

FIG. 1 schematically shows a user 100 wearing an augmented reality computing device 102 and viewing a physical environment 104. Augmented reality computing device 102 includes one or more see-through, near-eye displays 106 configured to present virtual imagery to eyes of the user, as will be described below. FIG. 1 also shows a field of view (FOV) 108 of the user, indicating the area of environment 104 visible to user 100 from the illustrated vantage point.

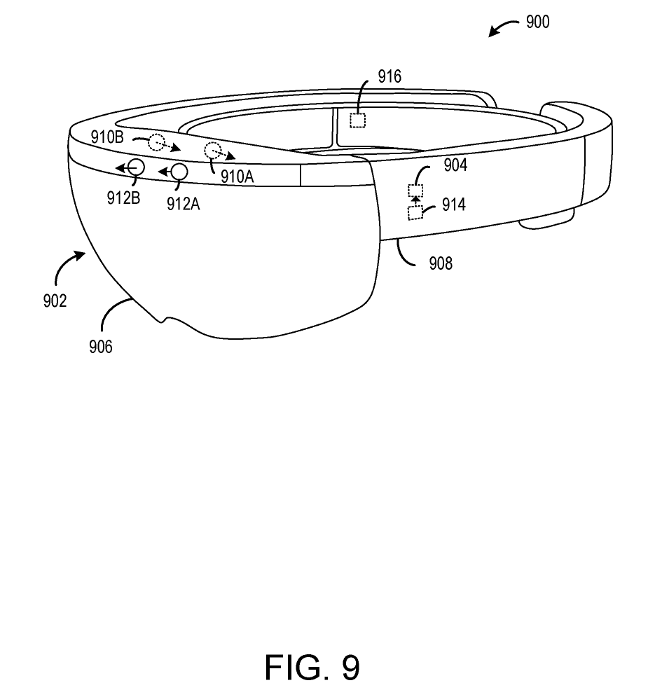

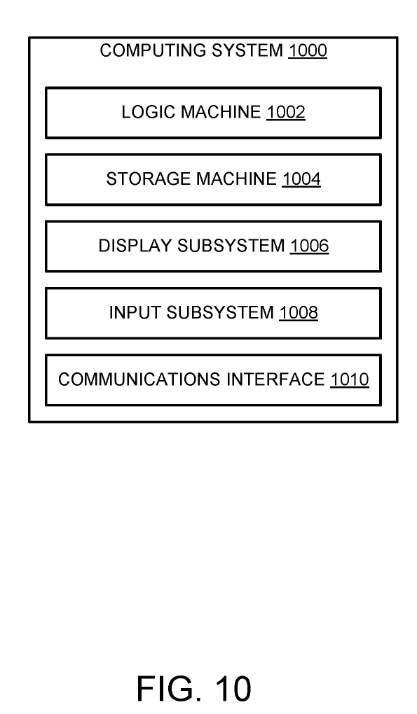

Though the term “augmented reality computing device” is generally used herein to describe a head mounted display device (HMD) including one or more see-through, near-eye displays, devices having other form factors may instead be used to view and manipulate virtual imagery. For example, virtual objects may be presented and manipulated via a smartphone or tablet computer facilitating an augmented reality experience, and/or other suitable computing devices may instead be used. Augmented reality computing device 102 may be implemented as the augmented reality computing device 900 described below with respect to FIG. 9, and/or the computing system 1000 shown in FIG. 10.

Augmented reality computing device 102 may be an augmented reality computing device that allows user 100 to directly view a physical environment through a partially transparent near-eye display, or augmented reality computing device 102 may be fully opaque and present imagery of a real world environment as captured by a front-facing camera. To avoid repetition, experiences provided by both implementations are referred to as “augmented reality” and the computing devices used to provide the augmented reality experiences are referred to as “augmented reality computing devices.” It will be appreciated that regardless of what type of augmented reality computing device is used, FIG. 1 shows at least some virtual imagery that is only visible to a user of an augmented reality computing device.

Specifically, FIG. 1 shows a virtual object 110 taking the form of a tall cylinder. Virtual object 110 is being presented to the user as part of an augmented reality environment, in which real objects in the user's surroundings are visible along with virtual imagery rendered by the augmented reality computing device. As will be described below, virtual object 110 may be presented at a particular screen-space position on the one or more near-eye displays 106 of augmented reality computing device 102, such that the virtual object appears to occupy a three-dimensional world-space position in physical environment 104 from the perspective of user 100.

In FIG. 1, a portion of the virtual object is occupying a position that falls within a shadow cast by a physical object (i.e., couch 114) present in the physical environment. However, as shown, the appearance of virtual object 110 is not affected by its position within shadow 112. In particular, virtual object 110 is shown as having a uniform brightness, even though a physical object occupying the same position would be partially shadowed by couch 114. Virtual object 110 therefore may not appear as realistic or tangible to user 100 as it would if realistic lighting effects were applied.

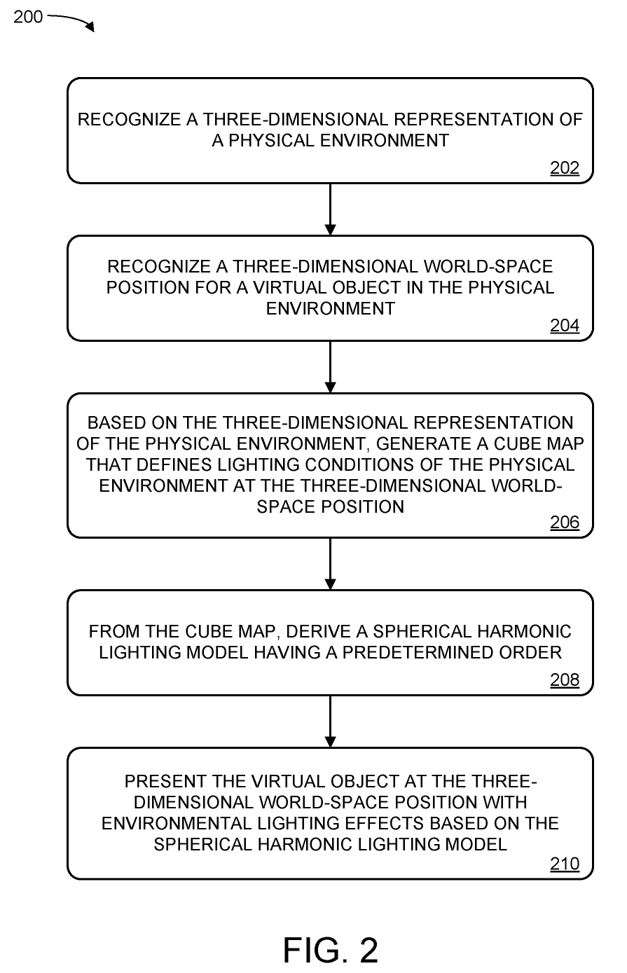

Accordingly, FIG. 2 illustrates an example method 200 for lighting virtual objects with environmental lighting effects. At 202, method 200 includes recognizing a three-dimensional representation of a physical environment. In some implementations, recognizing a three-dimensional representation may include generating the three-dimensional representation based on sensor data collected by one or more sensors, the sensor data indicating positions of physical objects in the physical environment. Such sensors may include, for example, one or more visible light cameras and one or more depth cameras, in addition to or as an alternative to any other suitable sensors that the augmented reality computing device is equipped with and/or usable with. Examples of suitable sensors that may be used with an augmented reality computing device are described below with respect to FIG. 9.

As indicated above, sensor data used to build a three-dimensional representation of a physical environment may indicate positions of physical objects in the physical environment. For example, data taken from visible light and/or depth cameras may be used to determine the locations, sizes, and shapes of objects, furniture, people, walls, floors, etc., in a physical environment. The augmented reality computing device may then use this data to generate a three-dimensional representation, which may comprise a surface reproduction (SR) “mesh,” wherein detected objects in the physical environment are represented as collections of triangles, or other polygons.

In some implementations, the sensor data may additionally indicate positions, colors, and/or intensities of light sources in the physical environment. In one possible implementation, this may be achieved when the augmented reality computing device is equipped with one or more visible light cameras configured to record the physical environment. For example, such cameras can provide a feed including information regarding lighting conditions in the environment, allowing the augmented reality computing device to detect both physical objects and light sources in the environment. Such a feed may comprise a series of individual images or frames, captured with any suitable frequency.

In some cases, light sources (such as lightbulbs/fixtures, windows, computer monitors, etc.) may be visible in images captured by the visible light camera(s), allowing the augmented reality computing device to directly determine the positions of the light sources within the physical environment, as well as determine the colors and intensities of the light sources. In other cases, the light sources themselves may not be visible in images captured by the visible light cameras, though their positions, colors, and/or intensities may still be inferred by observing the brightness and color of physical objects, identifying the locations and angles of shadows in the environment, detecting light reflecting off surfaces in the environment, etc. Any information regarding lighting conditions collected by the augmented reality computing device may be included in the three-dimensional representation of the physical environment, and taken into account when presenting virtual objects.

Depending on a current position and perspective of the augmented reality computing device, the augmented reality computing device may have more information regarding objects and lighting in some parts of the physical environment than in others. Further, positions of physical objects and lighting conditions in the physical environment can change while the augmented reality computing device is in use. Accordingly, the augmented reality computing device may be configured to update the three-dimensional representation as new sensor data is collected. The three-dimensional representation may be updated with any suitable frequency. For example, the three-dimensional representation may be updated each time new sensor data is collected, updated at a set frequency, updated upon receiving a user prompt, updating any time newly collected sensor data is inconsistent with the current three-dimensional representation, etc.

It will be appreciated that the specific sensor data used to construct the three-dimensional representation, as well as the specific information included in the three-dimensional representation, can vary from implementation to implementation. While the three-dimensional representation was described above as taking the form of a mesh defining physical objects as sets of polygons, a three-dimensional representation of a physical environment may take any suitable form. In general, a three-dimensional representation of a physical environment will include some indication of the positions of physical objects in the physical environment, as well as lighting conditions of the physical environment.

In some cases, recognizing the three-dimensional representation of the physical environment may not involve generating the three-dimensional representation on-the-fly from sensor data, as described above. Rather, the three-dimensional representation of the physical environment may be generated in advance, either by the augmented reality computing device, or by another device. For example, a user may use an augmented reality computing device in a known location, such as a room in the user's house or a demonstration environment at a store. In such cases, the augmented reality computing device may load a three-dimensional representation previously generated for whichever environment the augmented reality computing device is currently occupying. In some cases, a hybrid solution may be used, in which a previously-generated three-dimensional representation is augmented or modified based on sensor data collected while the augmented reality computing device is in use.

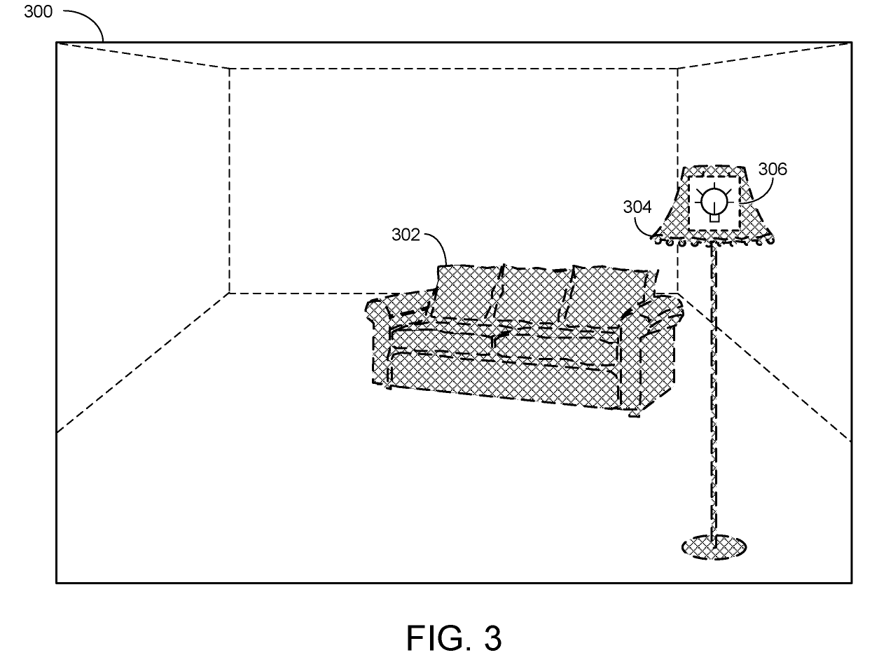

An example three-dimensional representation 300 of a physical environment is schematically shown in FIG. 3. Specifically, three-dimensional representation 300 is a representation of physical environment. 104 shown in FIG. 1. Three-dimensional representation 300 may be recognized by an augmented reality computing device during the process of presenting virtual objects with environmental lighting effects. As described above, three-dimensional representation 300 may be generated by an augmented reality computing device (e.g., augmented reality computing device 102) based on collected sensor data. Alternatively, three-dimensional representation 300 may be generated in advance.

As shown, three-dimensional representation 300 includes a representation 302 of couch 114, and a representation 304 of a lamp. The lightbulb icon 306 indicates that the augmented reality computing device has detected a light source in the physical environment at the position of the icon. Lightbulb icon 306 is shown in FIG. 3 as a visual aid, and it will be appreciated that a three-dimensional representation of a physical environment need not represent the positions of light sources with visible icons. Rather, lightbulb icon 306 is intended only to convey that the three-dimensional representation includes some information regarding the lighting conditions in the physical environment. Further, while not indicated, it should be understood that the walls, floor, and ceiling may be modeled and included in the three-dimensional representation.

Returning to FIG. 2, at 204, method 200 includes recognizing a three-dimensional world-space position for a virtual object in the physical environment. Recognizing a three-dimensional world-space position of a virtual object includes identifying the three-dimensional world-space position in the physical environment at which the virtual object should appear, from the perspective of the wearer of the augmented reality computing device. This position may be specified in any suitable manner. In some implementations, a world-space-coordinate system may be mapped to a virtual-space-coordinate system so that the virtual position of the virtual object in the virtual space may be mapped to a corresponding world space position in the real world.

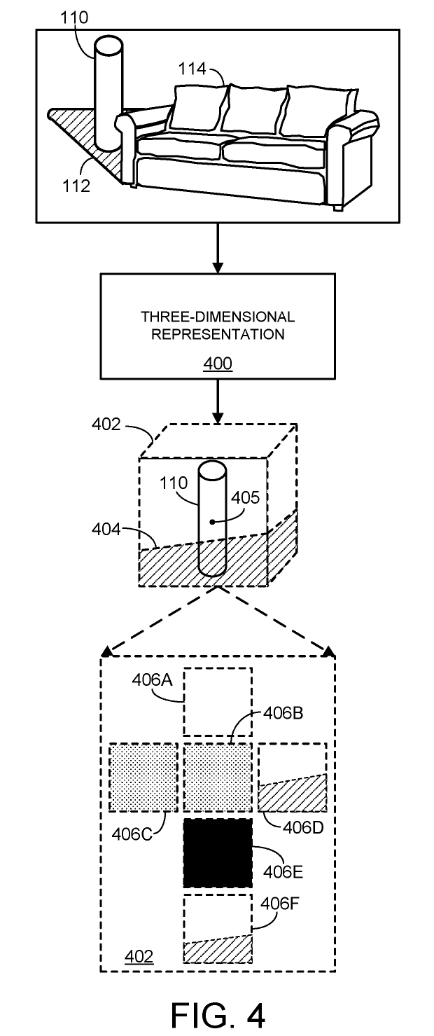

At 206, method 200 includes, based on the three-dimensional representation of the physical environment, generating a cube map that defines lighting conditions of the physical environment at the three-dimensional world-space position. Generation of a cube map is schematically illustrated in FIG. 4, which shows a portion of physical environment 104 from FIG. 1, including virtual object 110, shadow 112, and couch 114. FIG. 4 also shows a three-dimensional representation 400 of this portion of the physical environment. Three-dimensional representation 400 is recognized by the augmented reality computing device, after being generated by the augmented reality computing device based on sensor data, or generated in advance and loaded as needed.

From three-dimensional representation 400, the augmented reality computing device generates a cube map 402 defining lighting conditions of the physical environment at the three-dimensional world-space position of the virtual object (i.e., lighting conditions of physical environment 104 at the location of virtual object 110). Because the augmented reality computing device already has the three-dimensional representation of the physical environment, the process of generating cube map 402 can be performed without requiring significant processing power. As shown in FIG. 4, cube map 402 includes a shadow 404 covering a portion of virtual object 110. Shadow 404 is a representation of the lighting conditions in the physical environment, in that it shows how virtual object 110 would be affected by the lighting conditions if it was a physical object. In other words, shadow 404 of cube map 402 shows how virtual object 110 should be affected by shadow 112 in the physical environment.

In some cases, the cube map may be centered on a center point of the virtual object, such as center point 405 of virtual object 110. A center point of a virtual object may be defined in a variety of suitable ways. For example, a center point may be a geometric center of a virtual object, a center of mass of the virtual object, an origin defined by a coordinate system, a user-defined center point, etc. Alternatively, a cube map may have any orientation relative to a virtual object, and need not be centered on a center point.

A cube map as described herein can take a variety of suitable forms, though in general a cube map will have six faces surrounding the center of the cube map (i.e., the position of the virtual object). Each face of the cube map defines the lighting conditions that an observer positioned in the center of the cube map would see if they looked at the physical environment through that face of the cube map. In other words, each face of the cube map can be said to define lighting conditions that are applied to each of six sides of the virtual object.

In FIG. 4, cube map 402 is shown in an “unwrapped” state, in which each of its six faces 406A-406F are visible. Face 406A shows the lighting conditions applied to the top of the virtual object, face 406B shows lighting conditions applied to the rear of the virtual object (relative to the observer), faces 406C and 406D show lighting conditions applied to the respective left and right sides of the virtual object (relative to the observer), face 406E shows lighting conditions applied to the bottom of the virtual object, and face 406F shows lighting conditions applied to the front of the virtual object. Notably, faces 406D and 406 show how the virtual object should be affected by shadow 112. Face 406A is brighter than faces 406B and 406C, as these sides of the virtual object receive less light from the light source than the top of the virtual object. Similarly, the bottom of the virtual object receives no light at all (as it is occluded by the floor of the virtual environment), so face 406E is completely dark.

A cube map may be stored by an augmented reality computing device in a variety of suitable ways. For example, each face of the cube map may essentially comprise a separate texture map, which may have any suitable resolution. Each cube map therefore may be saved as six different texture maps. Cube maps taking this form optionally can be used to present virtual objects with environmental lighting effects. Alternatively, after generating the cube map, a spherical harmonic lighting model can be derived from the cube map, and the spherical harmonic lighting model can be used to present virtual objects with environmental lighting effects, as will be described below. Use of a spherical harmonic lighting model can improve computational efficiency.

Returning to FIG. 2, at 208, method 200 includes, from the cube map, deriving a spherical harmonic lighting model having a predetermined order. Spherical harmonics are mathematical relationships that can be used to represent functions defined on the surface of a sphere. Spherical harmonics of increasing complexity (i.e., higher order) can be used to improve accuracy at a cost of computational efficiency. For example, the simplest possible spherical harmonic (i.e., a 1^{st} order function) can be used as the basis for a spherical harmonic lighting model requiring only a single term. Such a 1^{st} order spherical harmonic lighting model will require minimal computer memory and processing power to store and maintain, though only produces satisfactory results for basic lighting effects, such as occlusions (e.g., is the virtual object shadowed or not).

More complicated spherical harmonic lighting models can be derived that require more input terms to define, and will require more memory and processing power to maintain, though will provide more realistic environmental lighting effects. For example, the spherical harmonic lighting model derived from the cube map may be a 3^{rd} order spherical harmonic lighting model. In general, a spherical harmonic lighting model having any predetermined order may be derived from the cube map. A predetermined order of the spherical harmonic lighting model may be selected that provides a suitable compromise between lighting effect realism and computer resources required to define and maintain the model.

A spherical harmonic lighting model can be derived from a cube map using any suitable technique. For example, a variety of conversion functions are usable to project a cube map, or irradiance maps taking other forms, into a spherical harmonic. Depending on the predetermined order that is selected for the spherical harmonic lighting model, deriving the spherical harmonic lighting model from the cube map can comprise a form of compression, or low-pass filtering. For example, if a relatively detailed cube map is converted into a 3^{rd} order spherical harmonic lighting model, then higher frequency terms will be discarded, and the computer memory and processing power required to provide environmental lighting effects can be reduced.

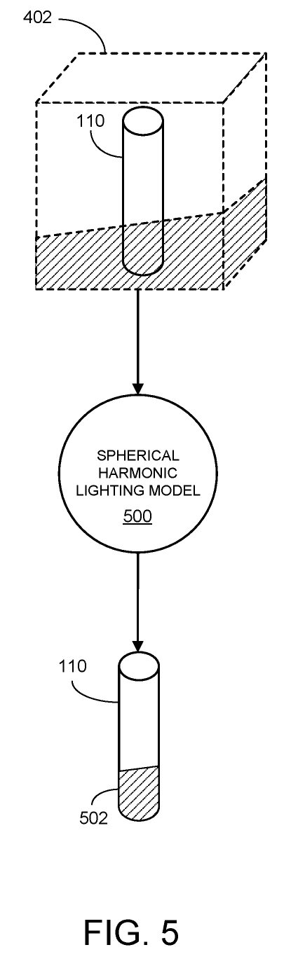

Deriving a spherical harmonic lighting model from a cube map is schematically illustrated in FIG. 5. Specifically, FIG. 5 shows cube map 402 from FIG. 4 centered on virtual object 110. From cube map 402, the augmented reality computing device derives a spherical harmonic lighting model 500 that is used to light virtual object 110 with environmental lighting effect 502. As described above, a spherical harmonic lighting model may have any suitable predetermined order, and it may be derived from cube map 402 using any suitable technique. Lighting virtual object 110 based on spherical harmonic lighting model 500 rather than cube map 402 can provide similarly realistic environmental lighting effects, while requiring less computer resources. These advantages become particularly evident when multiple virtual objects are presented at once.

The above description focuses on generating cube maps and spherical harmonic lighting models as needed, after recognizing a three-dimensional world-space position for a virtual object. However, in other implementations, spherical harmonic lighting models can be generated in advance that describe lighting conditions for three-dimensional world-space positions that are not yet associated with virtual objects. In particular, the augmented reality computing device may, for any given physical environment, generate a plurality of cube maps at different locations, and derive a plurality of spherical harmonic lighting models from the plurality of cube maps. Such spherical harmonic lighting models may be distributed throughout the physical environment in any suitable arrangement, such as a grid, for example. Any virtual objects presented in the physical environment can then be lit with environmental lighting conditions based on one or more spherical harmonic lighting models having a similar three-dimensional world-space position to the virtual object. For example, the virtual object may be presented with environmental lighting effects based on the closest spherical harmonic lighting model to the virtual object, or presented with environmental lighting effects that are defined based on a blending (e.g., interpolation) of multiple nearby spherical harmonic lighting models.

Returning to FIG. 2, at 210, method 200 includes presenting the virtual object at the three-dimensional world-space position with environmental lighting effects based on the spherical harmonic lighting model. Environmental lighting effects can take a variety of suitable forms, depending on the specific lighting conditions detected in the physical environment. For example, presenting the virtual objects with environmental lighting effects can include adjusting one or more of a brightness and a color of a locus of the virtual object based on a proximity of the locus to a light source. In other words, if a particular locus of a virtual object is near a bright red light, then that locus may be presented as being redder than loci that are further from the red light source. Similarly, if some obstacle is present between a locus of the virtual object and a light source (i.e., the locus is shadowed by the obstacle), then the locus may be presented with a reduced brightness relative to other loci of the virtual object.

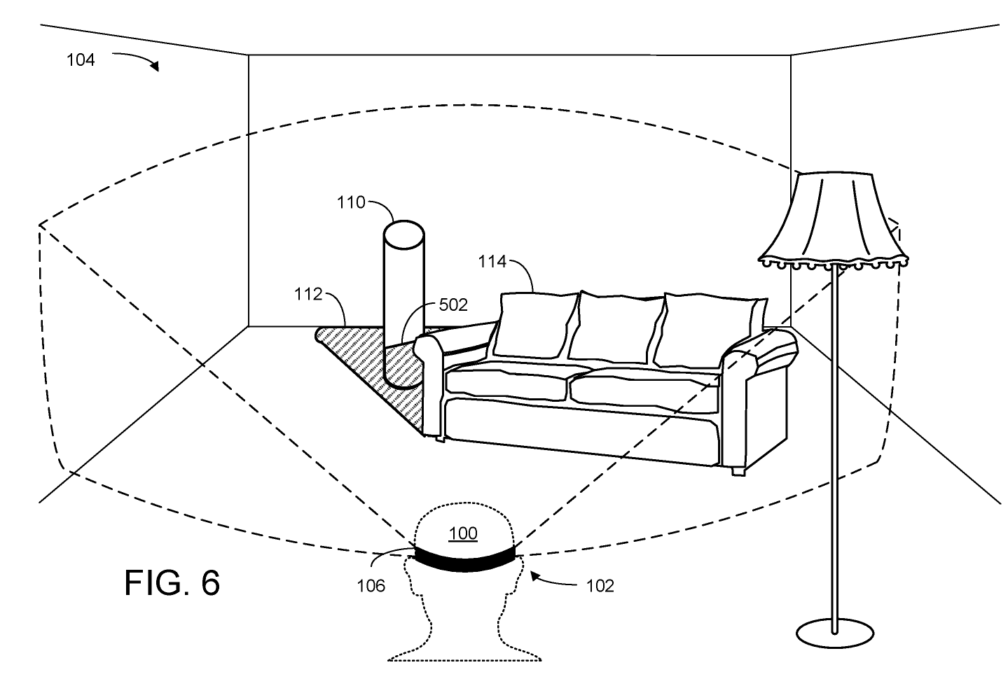

Presentation of a virtual object with environmental lighting effects is schematically illustrated in FIG. 6, which again shows physical environment 104 from FIG. 1. Specifically, FIG. 6 shows user 100 using augmented reality computing device 102 to view environment 104 via near-eye display 106. Virtual object 110 is presented at the same three-dimensional world-space position, such that a portion of virtual object 110 falls within shadow 112 cast by couch 114. However, in FIG. 6, virtual object 110 is presented with environmental lighting effect 502 based on spherical harmonic 500 shown in FIG. 5. As such, virtual object 110 is presented with lighting effects that are consistent with lighting conditions in physical environment 104. Specifically, virtual object 110 appears to be affected by shadow 112.

Though only one virtual object (i.e., virtual object 110) is shown in FIG. 6, it will be appreciated that the environmental lighting techniques described herein can be used to present any number of virtual objects with environmental lighting conditions. For example, in some implementations, the virtual object may be one of a plurality of virtual objects presented by an augmented reality computing device. In such cases, each particular virtual object of the plurality can be presented with environmental lighting effects based on a spherical harmonic lighting model of the particular virtual object at a corresponding three-dimensional world-space position of the virtual object.

In some cases, the lighting effects that should be applied to a virtual object can change over time, either because lighting conditions of the physical environment change, or one or more properties of the virtual object (e.g., shape, size, position, color, and/or reflectivity) change over time. As such, a different spherical harmonic lighting model may be used as the basis for lighting a virtual object for each of a series of subsequent time frames. For each subsequent time frame, the augmented reality computing device may recognize a subsequent three-dimensional world-space position for the virtual object in the physical environment, and generate a subsequent cube map that defines lighting conditions of the physical environmental at the subsequent three-dimensional world-space position. From the subsequent cube map, the augmented reality computing device can then derive a subsequent spherical harmonic lighting model having a predetermined order. The virtual object can then be presented at the subsequent three-dimensional world-space position with subsequent environmental lighting effects based on the subsequent spherical harmonic lighting model. In other words, for each time frame of a plurality of time frames, the virtual object can be lit with environmental lighting effects based on lighting conditions of the physical environment and the subsequent three-dimensional world-space position of the virtual object.

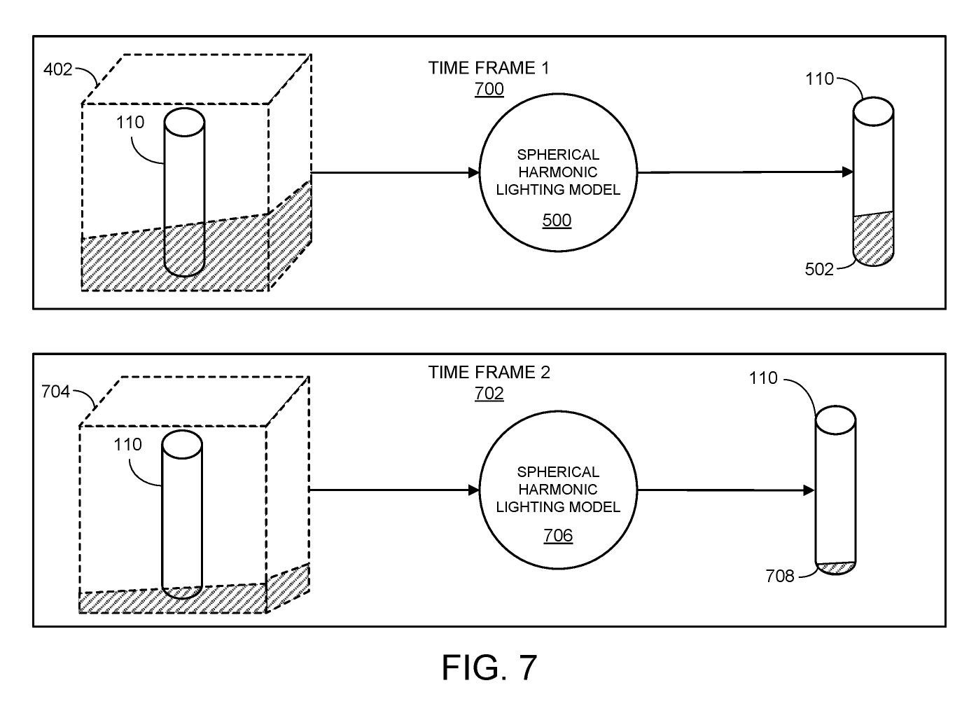

Presentation of a virtual object with environmental lighting effects during multiple time frames is schematically illustrated in FIG. 7. Specifically, FIG. 7 shows spherical harmonic lighting model 500 being derived from cube map 402, and presentation of virtual object 110 with environmental lighting effect 502 based on spherical harmonic lighting model 500, during a first time frame 700. FIG. 7 also shows a subsequent time frame 702, in which a three-dimensional world-space position of virtual object 110 has changed. Accordingly, the augmented reality computing device has generated a subsequent cube map 704, showing that now a much smaller portion of virtual object 110 falls within the shadow. From subsequent cube map 704, the augmented reality computing device derives subsequent spherical harmonic lighting model 706. Based on subsequent spherical harmonic lighting model 706, the augmented reality computing device presents virtual object 110 with subsequent environmental lighting effect 708, according to the updated three-dimensional world-space position of the virtual object.

In some cases, the augmented reality computing device may generate a completely new cube map and spherical harmonic lighting model for each time frame. In other cases, for each subsequent time frame, the augmented reality computing device may simply update the cube map and/or spherical harmonic lighting model from a preceding time frame, based on changes in the physical environment and/or virtual object. Further, it will be appreciated that each time frame may represent any suitable length of time. In one implementation, the cube map and spherical harmonic lighting model may be dynamically updated each image frame. In other implementations, updates occur less frequently, thus requiring less computation.

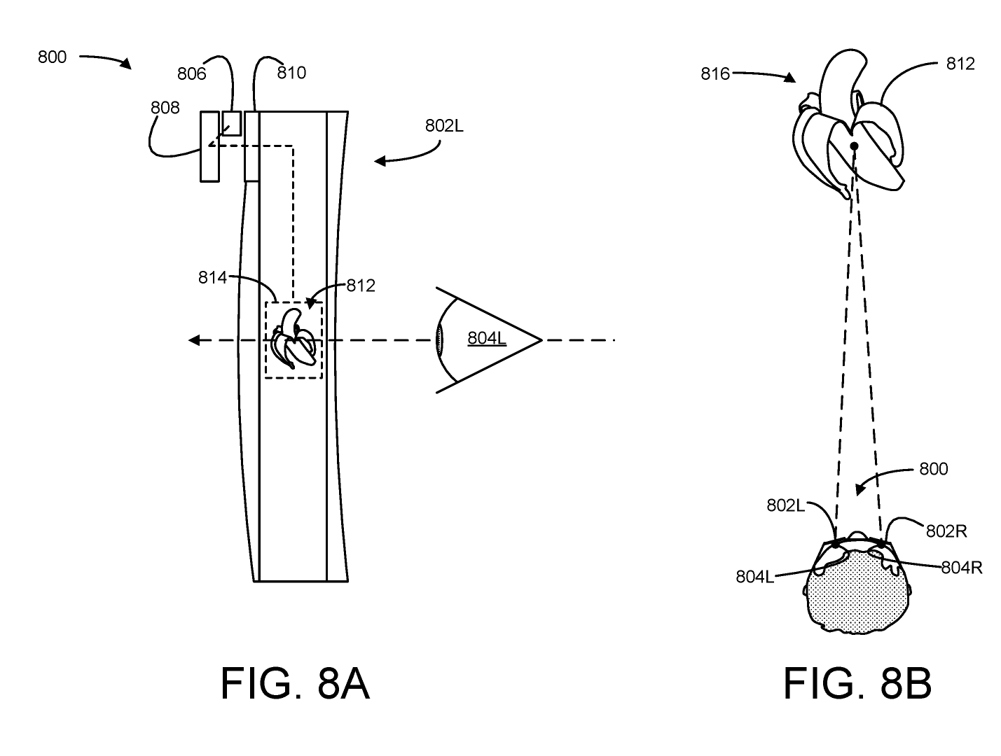

Displaying of a digital image may be performed in a variety of ways using a variety of suitable technologies. For example, in some implementations, the near-eye display associated with an augmented reality computing device may include two or more microprojectors, each configured to project light on or within the near-eye display. FIG. 8A shows a portion of an example near-eye display 800. Near-eye display 800 includes a left, microprojector 802L situated in front of a user's left eye 804L. It will be appreciated that near-eye display 800 also includes a right microprojector 802R situated in front of the user's right eye 804R, not visible in FIG. 8A.

The near-eye display includes a light source 806 and a liquid-crystal-on-silicon (LCOS) array 808. The light source may include an ensemble of light-emitting diodes (LEDs)—e.g., white LEDs or a distribution of red, green, and blue LEDs. The light source may be situated to direct its emission onto the LCOS array, which is configured to form a display image based on control signals received from a logic machine associated with an augmented reality computing device. The LCOS array may include numerous individually addressable display pixels arranged on a rectangular grid or other geometry, each of which is usable to show an image pixel of a digital image. In some embodiments, pixels reflecting red light may be juxtaposed in the array to pixels reflecting green and blue light, so that the LCOS array forms a color image. In other embodiments, a digital micromirror array may be used in lieu of the LCOS array, or an active-matrix LED array may be used instead. In still other embodiments, transmissive, backlit LCD or scanned-beam technology may be used to form the display image.

In some embodiments, the display image from LCOS array 808 may not be suitable for direct viewing by the user of near-eye display 800. In particular, the display image may be offset from the user's eye, may have an undesirable vergence, and/or a very small exit pupil (i.e., area of release of display light, not to be confused with the user's anatomical pupil). In view of these issues, the display image from the LCOS array may be further conditioned en route to the user's eye. For example, light from the LCOS array may pass through one or more lenses, such as lens 810, or other optical components of near-eye display 800, in order to reduce any offsets, adjust vergence, expand the exit pupil, etc.

Light projected by each microprojector 802 may take the form of a virtual image visible to a user, and occupy a particular screen-space position relative to the near-eye display, defined by a range of display pixels used to display the image. As shown, light from LCOS array 808 is forming virtual image 812 at screen-space position 814. Specifically, virtual image 812 is a banana, though any other virtual imagery may be displayed. A similar image may be formed by microprojector 802R, and occupy a similar screen-space position relative to the user's right eye. In some implementations, these two images may be offset from each other in such a way that they are interpreted by the user's visual cortex as a single, three-dimensional image. Accordingly, the user may perceive the images projected by the microprojectors as a three-dimensional object occupying a three-dimensional world-space position that is behind the screen-space position at which the virtual image is presented by the near-eye display.

This is shown in FIG. 8B, which shows an overhead view of a user wearing near-eye display 800. As shown, left microprojector 802L is positioned in front of the user's left eye 804L, and right microprojector 802R is positioned in front of the user's right eye 804R. Virtual image 812 is visible to the user as a virtual object present at a three-dimensional world-space position 814. In some cases, the user may move the virtual object such that it appears to occupy a different three-dimensional position. Additionally, or alternatively, movement of the user may cause a pose of the augmented reality computing device to change, requiring the augmented reality computing device to use different display pixels to present the virtual object so as to give the illusion that the virtual object has not moved relative to the user.

FIG. 9 shows aspects of an example augmented reality computing system 900 including a near-eye display 902. The augmented reality computing system 900 is a non-limiting example of the augmented reality computing devices described above, and may be usable for presenting virtual images with environmental lighting effects. Augmented reality computing system 900 may be implemented as computing system 1000 shown in FIG. 10.

The augmented reality computing system 900 may be configured to present any suitable type of augmented reality experience. In some implementations, the augmented reality experience includes a totally virtual experience in which the near-eye display 902 is opaque, such that the wearer is completely absorbed in the virtual imagery provided via the near-eye display 902.

In some implementations, the augmented reality experience includes an augmented-reality experience in which the near-eye display 902 is wholly or partially transparent from the perspective of the wearer, to give the wearer a clear view of a surrounding physical space. In such a configuration, the near-eye display 902 is configured to direct display light to the user's eye(s) so that the user will see augmented-reality objects that are not actually present in the physical space. In other words, the near-eye display 902 may direct display light to the user's eye(s) while light from the physical space passes through the near-eye display 902 to the user's eye(s). As such, the user's eye(s) simultaneously receive light from the physical environment and display light.

In such augmented-reality implementations, the augmented reality computing system 900 may be configured to visually present augmented-reality objects that appear body-locked and/or world-locked. A body-locked augmented-reality object may appear to move along with a perspective of the user as a pose (e.g., six degrees of freedom (DOF): x, y, z, yaw, pitch, roll) of the augmented reality computing system 900 changes. As such, a body-locked, augmented-reality object may appear to occupy the same portion of the near-eye display 902 and may appear to be at the same distance from the user, even as the user moves in the physical space. Alternatively, a world-locked, augmented-reality object may appear to remain in a fixed location in the physical space, even as the pose of the augmented reality computing system 900 changes. When the augmented reality computing system 900 visually presents world-locked, augmented-reality objects, such a augmented reality experience may be referred to as a mixed-reality experience.

In some implementations, the opacity of the near-eye display 902 is controllable dynamically via a dimming filter. A substantially see-through display, accordingly, may be switched to full opacity for a fully immersive augmented reality experience.

The augmented reality computing system 900 may take any other suitable form in which a transparent, semi-transparent, and/or non-transparent display is supported in front of a viewer's eye(s). Further, implementations described herein may be used with any other suitable computing device, including but not limited to wearable computing devices, mobile computing devices, laptop computers, desktop computers, smart phones, tablet computers, etc.

Any suitable mechanism may be used to display images via the near-eye display 902. For example, the near-eye display 902 may include image-producing elements located within lenses 906. As another example, the near-eye display 902 may include a display device, such as a liquid crystal on silicon (LCOS) device or OLED microdisplay located within a frame 908. In this example, the lenses 906 may serve as, or otherwise include, a light guide for delivering light from the display device to the eyes of a wearer. Additionally or alternatively, the near-eye display 902 may present left-eye and right-eye virtual images via respective left-eye and right-eye displays.

The augmented reality computing system 900 includes an on-board computer 904 configured to perform various operations related to receiving user input (e.g., gesture recognition, eye gaze detection), visual presentation of virtual images on the near-eye display 902, and other operations described herein. In some implementations, some to all of the computing functions described above, may be performed off board.

The augmented reality computing system 900 may include various sensors and related systems to provide information to the on-board computer 904. Such sensors may include, but are not limited to, one or more inward facing image sensors 910A and 910B, one or more outward facing image sensors 912A and 912B, an inertial measurement unit (IMU) 914, and one or more microphones 916. The one or more inward facing image sensors 910A, 910B may be configured to acquire gaze tracking information from a wearer's eyes (e.g., sensor 910A may acquire image data for one of the wearer's eye and sensor 910B may acquire image data for the other of the wearer's eye).

The on-board computer 904 may be configured to determine gaze directions of each of a wearer's eyes in any suitable manner based on the information received from the image sensors 910A, 910B. The one or more inward facing image sensors 910A, 910B, and the on-board computer 904 may collectively represent a gaze detection machine configured to determine a wearer's gaze target on the near-eye display 902. In other implementations, a different type of gaze detector/sensor may be employed to measure one or more gaze parameters of the user's eyes. Examples of gaze parameters measured by one or more gaze sensors that may be used by the on-board computer 904 to determine an eye gaze sample may include an eye gaze direction, head orientation, eye gaze velocity, eye gaze acceleration, change in angle of eye gaze direction, and/or any other suitable tracking information. In some implementations, eye gaze tracking may be recorded independently for both eyes.

The one or more outward facing image sensors 912A, 912B may be configured to measure physical environment attributes of a physical space. In one example, image sensor 912A may include a visible-light camera configured to collect a visible-light image of a physical space. Further, the image sensor 912B may include a depth camera configured to collect a depth image of a physical space. More particularly, in one example, the depth camera is an infrared time-of-flight depth camera. In another example, the depth camera is an infrared structured light depth camera.

Data from the outward facing image sensors 912A, 912B may be used by the on-board computer 904 to detect movements, such as gesture-based inputs or other movements performed by a wearer or by a person or physical object in the physical space. In one example, data from the outward facing image sensors 912A, 912B may be used to detect a wearer input performed by the wearer of the augmented reality computing system 900, such as a gesture. Data from the outward facing image sensors 912A. 912B may be used by the on-board computer 904 to determine direction/location and orientation data (e.g., from imaging environmental features) that enables position/motion tracking of the augmented reality computing system 900 in the real-world environment. In some implementations, data from the outward facing image sensors 912A, 912B may be used by the on-board computer 904 to construct still images and/or video images of the surrounding environment from the perspective of the augmented reality computing system 900.

The IMU 914 may be configured to provide position and/or orientation data of the augmented reality computing system 900 to the on-board computer 904. In one implementation, the IMU 914 may be configured as a three-axis or three-degree of freedom (3DOF) position sensor system. This example position sensor system may, for example, include three gyroscopes to indicate or measure a change in orientation of the augmented reality computing system 900 within 3D space about three orthogonal axes (e.g., roll, pitch, and yaw).

In another example, the IMU 914 may be configured as a six-axis or six-degree of freedom (6DOF) position sensor system. Such a configuration may include three accelerometers and three gyroscopes to indicate or measure a change in location of the augmented reality computing system 900 along three orthogonal spatial axes (e.g., x, y, and z) and a change in device orientation about three orthogonal rotation axes (e.g., yaw, pitch, and roll). In some implementations, position and orientation data from the outward facing image sensors 912A, 912B and the IMU 914 may be used in conjunction to determine a position and orientation (or 6DOF pose) of the augmented reality computing system 900.

The augmented reality computing system 900 may also support other suitable positioning techniques, such as GPS or other global navigation systems. Further, while specific examples of position sensor systems have been described, it will be appreciated that any other suitable sensor systems may be used. For example, head pose and/or movement data may be determined based on sensor information from any combination of sensors mounted on the wearer and/or external to the wearer including, but not limited to, any number of gyroscopes, accelerometers, inertial measurement units, GPS devices, barometers, magnetometers, cameras (e.g., visible light cameras, infrared light cameras, time-of-flight depth cameras, structured light depth cameras, etc.), communication devices (e.g., WI FI antennas/interfaces), etc.

The one or more microphones 916 may be configured to measure sound in the physical space. Data from the one or more microphones 916 may be used by the on-board computer 904 to recognize voice commands provided by the wearer to control the augmented reality computing system 900.

The on-board computer 904 may include a logic machine and a storage machine, discussed in more detail below with respect to FIG. 10, in communication with the near-eye display 902 and the various sensors of the augmented reality computing system 900.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 1000 that can enact one or more of the methods and processes described above. In particular, computing system 1000 may generate a cube map from a three-dimensional representation of a virtual environment, derive a spherical harmonic lighting model from the cube map, and present virtual objects with environmental lighting effects based on the spherical harmonic lighting model. Computing system 1000 is shown in simplified form. Computing system 1000 may take the form of one or more personal computers, server computers, tablet computers, home-entertainment computers, network computing devices, augmented reality computing devices, gaming devices, mobile computing devices, mobile communication devices (e.g., smart phone), and/or other computing devices.

Computing system 1000 includes a logic machine 1002 and a storage machine 1004 Computing system 1000 may optionally include a display subsystem 1006, input subsystem 1008, communication subsystem 1010, and/or other components not shown in FIG. 10.

Logic machine 1002 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1004 includes one or more physical devices configured to hold instructions executable by the logic machine to implement the methods and processes described herein. When such methods and processes are implemented, the state of storage machine 1004 may be transformed—e.g., to hold different data.

Storage machine 1004 may include removable and/or built-in devices. Storage machine 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1004 may include volatile, nonvolatile, dynamic, static, read/write, read-only, random-access, sequential-access, location-addressable, file-addressable, and/or content-addressable devices.

It will be appreciated that storage machine 1004 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1002 and storage machine 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic machine 1002 executing instructions held by storage machine 1004. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1006 may be used to present a visual representation of data held by storage machine 1004. This visual representation may take the form of a graphical user interface (GUI). As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology. For example, display subsystem may be a near-eye display. Such display devices may be combined with logic machine 1002 and/or storage machine 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

In an example, a method for lighting virtual objects comprises: recognizing a three-dimensional representation of a physical environment; recognizing a three-dimensional world-space position for a virtual object in the physical environment; based on the three-dimensional representation of the physical environment, generating a cube map that defines lighting conditions of the physical environment at the three-dimensional world space position; from the cube map, deriving a spherical harmonic lighting model having a predetermined order; and presenting the virtual object at the three-dimensional world-space position with environmental lighting effects based on the spherical harmonic lighting model. In this example or any other example, the virtual object is presented via a near-eye display of an augmented reality computing device, and the virtual object is presented such that it appears to occupy the three-dimensional world-space position from a perspective of a wearer of the augmented reality computing device. In this example or any other example, recognizing the three-dimensional representation of the physical environment comprises generating the three-dimensional representation based on sensor data collected by one or more sensors, the sensor data indicating positions of physical objects in the physical environment. In this example or any other example, the sensor data further indicates positions, colors, and intensities of light sources in the physical environment. In this example or any other example, the one or more sensors include one or more visible light cameras and one or more depth cameras. In this example or any other example, the spherical harmonic lighting model is a 3^{rd} order spherical harmonic lighting model. In this example or any other example, the method further comprises, for each of a plurality of subsequent time frames: recognizing a subsequent three-dimensional world-space position for the virtual object in the physical environment; generating a subsequent cube map that defines lighting conditions of the physical environment at the subsequent three-dimensional world space position; from the subsequent cube map, deriving a subsequent spherical harmonic lighting model having the predetermined order; and presenting the virtual object at the subsequent three-dimensional world-space position with subsequent environmental lighting effects based on the subsequent spherical harmonic lighting model. In this example or any other example, the method further comprises, for each time frame of the plurality of time frames, dynamically lighting the virtual object with environmental lighting effects based on lighting conditions of the physical environment and subsequent three-dimensional world-space positions of the virtual object. In this example or any other example, the cube map is centered on a center point of the virtual object. In this example or any other example, presenting the virtual object with environmental lighting effects includes adjusting one or more of a brightness and a color of a locus of the virtual object based on a proximity of the locus to a light source. In this example or any other example, the virtual object is one of a plurality of virtual objects, and each particular virtual object of the plurality is presented with environmental lighting effects based on a spherical harmonic lighting model of the particular virtual object at a corresponding three-dimensional world-space position.

In an example, a method for lighting virtual objects comprises: recognizing a three-dimensional representation of a physical environment; recognizing a three-dimensional world-space position for a virtual object in the physical environment; and via a near-eye display, displaying the virtual object with environmental lighting effects based on a spherical harmonic lighting model derived from the three-dimensional representation of the physical environment such that the virtual object appears, from a perspective viewed through the near-eye display, at the three-dimensional world-space position in the physical environment. In this example or any other example, the spherical harmonic lighting model is derived from a cube map defining lighting conditions of the physical environment at the three-dimensional world-space position of the virtual object. In this example or any other example, recognizing the three-dimensional representation of the physical environment comprises generating the three-dimensional representation based on sensor data collected by one or more sensors, the sensor data indicating positions of physical objects in the physical environment and positions, colors, and intensities of light sources in the physical environment. In this example or any other example, the spherical harmonic lighting model is a 3^{rd} order spherical harmonic lighting model. In this example or any other example, the method further comprises, for each of a plurality of subsequent time frames: recognizing a subsequent three-dimensional world-space position for the virtual object in the physical environment; and via the near-eye display, displaying the virtual object with subsequent environmental lighting effects based on a subsequent spherical harmonic lighting model derived from the three-dimensional representation of the physical environment such that the virtual object appears, from the perspective viewed through the near-eye display, at the subsequent three-dimensional world-space position in the physical environment. In this example or any other example, the cube map is centered on a center point of the virtual object. In this example or any other example, presenting the virtual object with environmental lighting effects includes adjusting one or more of a brightness and a color of a locus of the virtual object based on a proximity of the locus to a light source. In this example or any other example, the virtual object is one of a plurality of virtual objects, and each particular virtual object of the plurality is presented with environmental lighting effects based on a spherical harmonic lighting model of the particular virtual object at a corresponding three-dimensional world-space position.

In an example, an augmented reality computing device comprises: a near-eye display; a logic machine; and a storage machine holding instructions executable by the logic machine to: generate a three-dimensional representation of a physical environment based on sensor data indicating positions of physical objects in the physical environment and positions, colors, and intensities of light sources in the physical environment; recognize a three-dimensional world-space position for the virtual object in the physical environment; based on the three-dimensional representation of the physical environment, generate a cube map that defines lighting conditions of the physical environment at the three-dimensional world space position; from the cube map, derive a 3^{rd} order spherical harmonic lighting model; and via the near-eye display, display the virtual object with environmental lighting effects based on the spherical harmonic lighting model such that the virtual object appears, from a perspective viewed through the near-eye display, at the three-dimensional world-space position in the physical environment.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for lighting virtual objects, comprising:
recognizing a three-dimensional representation of a physical environment;
recognizing a three-dimensional world-space position for a virtual object in the physical environment;
based on the three-dimensional representation of the physical environment, generating a cube map that defines lighting conditions of the physical environment at the three-dimensional world space position;
from the cube map, deriving a spherical harmonic lighting model having a predetermined order; and
presenting the virtual object at the three-dimensional world-space position with environmental lighting effects based on the spherical harmonic lighting model.

2. The method of claim 1, where the virtual object is presented via a near-eye display of an augmented reality computing device, and the virtual object is presented such that it appears to occupy the three-dimensional world-space position from a perspective of a wearer of the augmented reality computing device.

3. The method of claim 1, where recognizing the three-dimensional representation of the physical environment comprises generating the three-dimensional representation based on sensor data collected by one or more sensors, the sensor data indicating positions of physical objects in the physical environment.

4. The method of claim 3, where the sensor data further indicates positions, colors, and intensities of light sources in the physical environment.

5. The method of claim 3, where the one or more sensors include one or more visible light cameras and one or more depth cameras.

6. The method of claim 1, where the spherical harmonic lighting model is a 3^{rd} order spherical harmonic lighting model.

7. The method of claim 1, further comprising, for each of a plurality of subsequent time frames:
recognizing a subsequent three-dimensional world-space position for the virtual object in the physical environment;
generating a subsequent cube map that defines lighting conditions of the physical environment at the subsequent three-dimensional world space position;
from the subsequent cube map, deriving a subsequent spherical harmonic lighting model having the predetermined order; and
presenting the virtual object at the subsequent three-dimensional world-space position with subsequent environmental lighting effects based on the subsequent spherical harmonic lighting model.

8. The method of claim 7, further comprising, for each time frame of the plurality of time frames, dynamically lighting the virtual object with environmental lighting effects based on lighting conditions of the physical environment and subsequent three-dimensional world-space positions of the virtual object.

9. The method of claim 1, where the cube map is centered on a center point of the virtual object.

10. The method of claim 1, where presenting the virtual object with environmental lighting effects includes adjusting one or more of a brightness and a color of a locus of the virtual object based on a proximity of the locus to a light source.

11. The method of claim 1, where the virtual object is one of a plurality of virtual objects, and each particular virtual object of the plurality is presented with environmental lighting effects based on a spherical harmonic lighting model of the particular virtual object at a corresponding three-dimensional world-space position.

12. A method for lighting virtual objects, comprising:
recognizing a three-dimensional representation of a physical environment;
recognizing a three-dimensional world-space position for a virtual object in the physical environment; and
via a near-eye display, displaying the virtual object with environmental lighting effects based on a spherical harmonic lighting model derived from the three-dimensional representation of the physical environment such that the virtual object appears, from a perspective viewed through the near-eye display, at the three-dimensional world-space position in the physical environment.

13. The method of claim 12, where the spherical harmonic lighting model is derived from a cube map defining lighting conditions of the physical environment at the three-dimensional world-space position of the virtual object.

14. The method of claim 12, where recognizing the three-dimensional representation of the physical environment comprises generating the three-dimensional representation based on sensor data collected by one or more sensors, the sensor data indicating positions of physical objects in the physical environment and positions, colors, and intensities of light sources in the physical environment.

15. The method of claim 12, where the spherical harmonic lighting model is a 3^{rd} order spherical harmonic lighting model.

16. The method of claim 12, further comprising, for each of a plurality of subsequent time frames:
recognizing a subsequent three-dimensional world-space position for the virtual object in the physical environment; and
via the near-eye display, displaying the virtual object with subsequent environmental lighting effects based on a subsequent spherical harmonic lighting model derived from the three-dimensional representation of the physical environment such that the virtual object appears, from the perspective viewed through the near-eye display, at the subsequent three-dimensional world-space position in the physical environment.

17. The method of claim 12, where the cube map is centered on a center point of the virtual object.

18. The method of claim 12, where presenting the virtual object with environmental lighting effects includes adjusting one or more of a brightness and a color of a locus of the virtual object based on a proximity of the locus to a light source.

19. The method of claim 12, where the virtual object is one of a plurality of virtual objects, and each particular virtual object of the plurality is presented with environmental lighting effects based on a spherical harmonic lighting model of the particular virtual object at a corresponding three-dimensional world-space position.

20. An augmented reality computing device, comprising:
a near-eye display;
a logic machine; and
a storage machine holding instructions executable by the logic machine to:
generate a three-dimensional representation of a physical environment based on sensor data indicating positions of physical objects in the physical environment and positions, colors, and intensities of light sources in the physical environment;
recognize a three-dimensional world-space position for the virtual object in the physical environment;
based on the three-dimensional representation of the physical environment, generate a cube map that defines lighting conditions of the physical environment at the three-dimensional world space position;
from the cube map, derive a 3^{rd} order spherical harmonic lighting model; and
via the near-eye display, display the virtual object with environmental lighting effects based on the spherical harmonic lighting model such that the virtual object appears, from a perspective viewed through the near-eye display, at the three-dimensional world-space position in the physical environment.
